(19) United States
(12) Patent Application Publication
(10) Pub. No.: US 2009/0167680 A1
(43) Pub. Date: Jul. 2, 2009

(54) Electronic Apparatus

(75) Inventors: Yuusuke SUGIURA, Ome-shi (JP); Hironori MOTOE, Ome-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: Kabushiki Kaisha Toshiba, Tokyo (JP)

(21) Appl. No.: 12/191,974

(22) Filed: Aug. 14, 2008

(30) Foreign Application Priority Data
Dec. 27, 2007 (JP) 2007-338290

(51) Int. Cl. G06F 3/033

(52) U.S. Cl. 345/157

(57) ABSTRACT

According to one embodiment, an electronic apparatus includes: a first casing provided with a metal part, a pointing device and a circuit board, the pointing device being mounted on the circuit board, the circuit board being provided with a cover member for covering the pointing device; a second casing being joined to the first casing and having a hole made so as to expose a part of the cover member; a conductor being provided at a position opposed to a gap existing between the cover member and the second casing in the circuit board; and a conductive member for electrically connecting the conductor and the metal part.

### CROSS-REFERENCE TO RELATED APPLICATIONS

This application is based upon and claims the benefit of priority from Japanese Patent Application No. 2007-338290, filed on Dec. 27, 2007, the entire contents of which are incorporated herein by reference.

### BACKGROUND

1. Field

This invention relates to an electronic apparatus with a pointing device placed in a part of a casing and in particular to an electronic apparatus designed for enhancing resistance on static electricity of the pointing device by providing a path on the base side of the apparatus, wherein the path is for discharging static electricity entering the apparatus through the gap between the casing and the pointing device into the casing.

2. Description of the Related Art

In recent years, various electronic apparatuses have been developed and an electronic apparatus with a pointing device placed in a part of a casing has become widespread as a portable information terminal (personal digital assistant (FDA)) that can be used easily. Such an electronic apparatus is applied to an electronic dictionary, an electronic notebook, a notebook personal computer, a gaming apparatus, a mobile telephone, other various mobile apparatuses, for example.

The pointing device is placed, for example, so that a hole made on the front face of the casing allows at least a part of the pointing device is exposed outside.

With the described electronic apparatus, when the user operates the pointing device with a charged finger, static electricity may be applied through the gap part between an inner peripheral margin of the hole on the casing on the apparatus front face and an outer peripheral margin of the pointing device and may enter the apparatus inside, whereby function of the electronic apparatus may be impaired or a fault may occur.

Hitherto, the following has been proposed as a countermeasure against static electricity: The casing on the apparatus front face is formed of a conductive coating and shield plate structure provided by bonding resin and metal rather than a single material of resin and generated static electricity is discharged into outside along a face of the inner plate of the casing. Thus the static electricity is prevented from being applied directly to a printed circuit board in the electronic apparatus so that the pointing device is protected.

JP-A-2001-43764 proposes an art of intending entry prevention of static electricity into a printed circuit board, attenuation of static electricity, etc., to prevent a fault, malfunction, and the like, of the apparatus with the casing on the apparatus front face formed of a single material of resin by placing a resin sheet in the casing in a direction parallel to the casing plate face and discharging static electricity into outside along a face of the resin sheet.

However, to install an antenna on the casing for providing a communication function, it is not appropriate to form the casing on the apparatus front face of a conductive coating and shield plate, because the antenna characteristics are impaired then transmission and reception of a radio wave are impeded.

On the other hand, in the art described in the JP-A-2001-43764, when the resin sheet hole has to be made on a position where a button contact part is located at, there is a possibility that the path for discharging static electricity may become imperfect and that sufficient protection may be accomplished.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the Invention and not to limit the scope of the invention.

FIG. 1 is an exemplary exploded perspective view to show a component configuration of an electronic apparatus according to an embodiment of the invention;

FIG. 2 is an exemplary longitudinal sectional view to show a main part configuration of the electronic apparatus according to the embodiment;

FIG. 3 is an exemplary plan view to show the component configuration according to the embodiment; and

FIG. 4 is an exemplary longitudinal sectional view to show the component configuration according to the embodiment.

### DETAILED DESCRIPTION

Various embodiments according to the invention will be described hereinafter with reference to the accompanying drawings. In general, according to one embodiment of the invention, an electronic apparatus includes: a first casing provided with a metal part, a pointing device and a circuit board, the pointing device being mounted on the circuit board, the circuit board being provided with a cover member for covering the pointing device; a second casing being joined to the first casing and having a hole made so as to expose a part of the cover member; a conductor being provided at a position opposed to a gap existing between the cover member and the second casing in the circuit board; and a conductive member for electrically connecting the conductor and the metal part.

An embodiment of an electronic apparatus according to the invention will be explained with reference to the accompanying drawings.

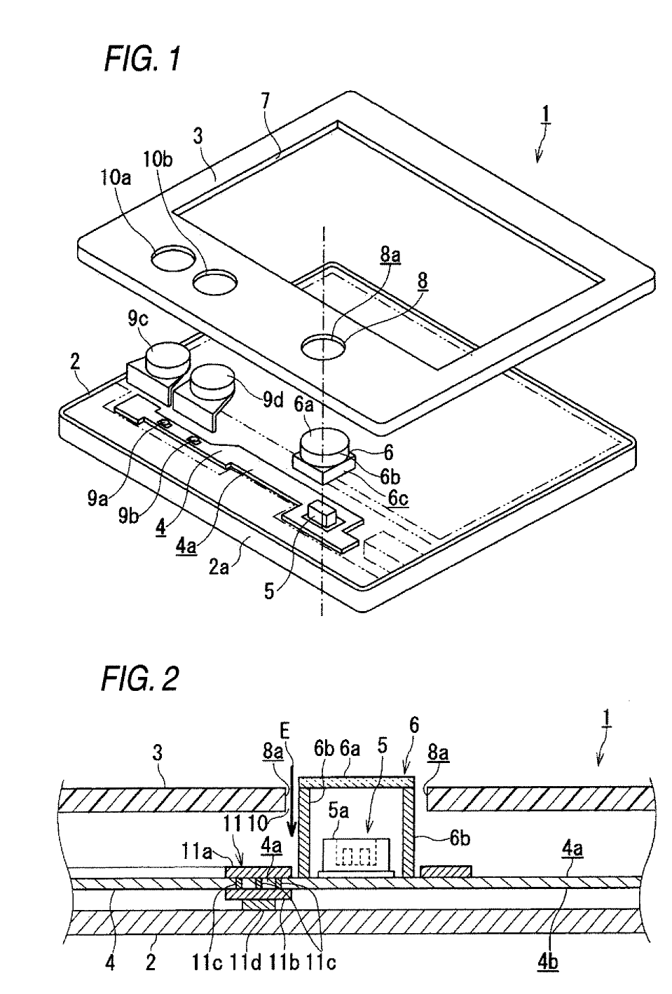

FIG. 1 is an exploded perspective view to schematically show components of an electronic apparatus according to an embodiment of the invention. As shown in FIG. 1, an electronic apparatus 1 of the embodiment includes a pair of casings 2 and 3 each shaped like a rectangular plate, opposed to each other and the opposed faces of the casings 2 and 3 are joined in a peripheral margin part projecting like a rib, thereby forming a thin-box-like casing for housing electronic components with a given spacing formed between the casings 2 and 3.

The one casing 2 shown in the lower part of FIG. 1 is a casing on the apparatus base side for housing the electronic apparatus therein and the casing 2 on the apparatus base side is formed of metal as a whole or a part requiring energization contains metal. The part requiring energization contains metal refers to a part adjacent to a pointing device described later in the casing 2 or the surrounding of the pointing device.

A circuit board 4 is fixed as it is placed along one side 2a of the casing 2 in the casing 2 on the apparatus base side. A pointing device 5 for cursor operation is mounted on the circuit board 4.

The pointing device 5 is shaped like a rectangular parallelepiped incorporating an optical switch, for example. A cylindrical cover member 6 for covering the surrounding of the pointing device 5 is placed above the pointing device 5. The cover member 6 is placed on the circuit board 4 and has an upper end wall 6a and a peripheral wall 6b formed of a translucent material of glass, etc., for example. The cover member 6 has an opening 6c on the opposite side to the upper end wall 6a. An insulator is used for the cover member 6.

The cover member 6 may be fixed onto the circuit board 4 or may be fitted into a hole 8 made on the casing 3 and then the circuit board 4 and the cover member 6 may come in contact with each other considering the component tolerance, etc.

The upper end wall 6a and the peripheral wall 6b form the upper part of the cover member 6 as a cylindrical shape, and a lower part 6d is shaped like a rectangular parallelepiped. The cover member 6 is put on the surrounding of the pointing device 5 and in this state, the components are mounted on the circuit board 4, whereby the whole of the surrounding of the pointing device 5 and the upper end part are covered. According to this cover structure, for the pointing device 5 having low resistance on static electricity, static electricity from the periphery of the pointing device 5 is shut off and the pointing device 5 is held in a state in which the resistance on static electricity of the pointing device 5 is high. The pointing device 5 emits light upward to the position of the hole 8 of the casing 3 from an upper face 4a of the circuit board 4 and sets the cursor move position by grasping motion of a finger of the operator moving on the upper end wall 6a of the cover member 6 according to light reflected from the finger of the operator.

As shown in FIG. 1, the casing 3 of the electronic apparatus 1 is shaped like a quadrangular frame having a display window 7; the whole is made of a resin or at least a part, namely, the part where the hole 8 is placed is made of a resin. The circular hole 8 for placing the pointing device 5 mounted on the circuit board 4 provided in the casing 2 on the apparatus base side is made in the casing 3 on the apparatus surface side. In the circular hole 8, the cover member 6 is formed by the upper end wall 6a and the peripheral wall 6b. The hole 8 is made on the casing 3 so as to expose a part of the cover member 6 covering the pointing device 5 and the cover member 6 (pointing device 5) is inserted in a state in which the cylindrical portion of the cover member 6 and an inner peripheral margin 8a of the hole 8 are spaced from each other with a given gap.

The circuit board 4 is provided on the upper face 4a with a pair of button switches 9a and 9b with a given spacing from each other on the opposite side to the position where the pointing device 5 is placed. The button switches 9a and 9b are provided for the user to perform screen operation, etc., other than the pointing operation and are operated using circular holes 10a and 10b made on the casing 3 of the front side of the apparatus and switch covers 9c and 9d provided in the holes 10a and 10b.

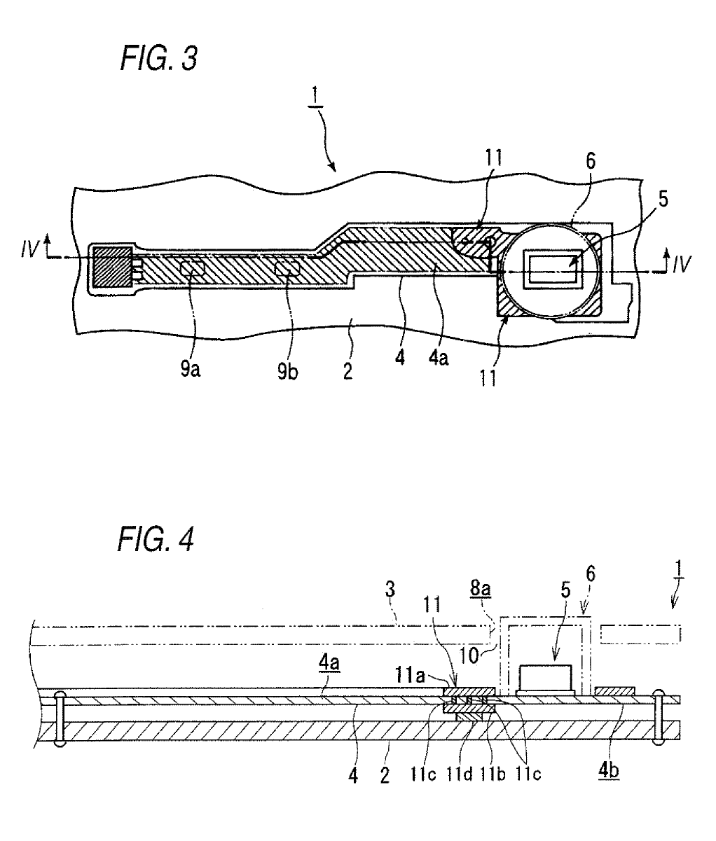

Next, the assembly structure of the electronic apparatus 1 will be discussed in detail with reference to FIGS. 2 to 4. FIG. 2 is a longitudinal sectional view to show, on an enlarged scale, the pointing device 5 of the electronic apparatus 1 and the peripheral configuration of the pointing device 5 shown in FIG. 1, FIG. 3 is a plan view of the circuit board 4 installing the pointing device 5, and FIG. 4 is a sectional view taken on line IV-IV in FIG. 3.

As shown in FIGS. 2 to 4, the casing 2 on the apparatus base side and the casing 3 on the apparatus surface side are placed in parallel with each other and the circuit board 4 is placed in parallel therebetween. The circular hole 8 for placing the pointing device 5 is made on the casing 3 on the apparatus front face and the pointing device 5 is installed on the circuit board 4 in the center of the hole 8. The height of the pointing device 5 is set so as to become smaller than the distance between the circuit board 4 and the casing 3.

The cover member 6 is also installed on the circuit board 4 in the coaxial placement surrounding the pointing device 5 and the peripheral wall 6b of the cover member 6 is placed at a roughly midway position between a side face 5a of the pointing device 5 and the inner peripheral margin 8a of the hole 8 of the casing 3 on the apparatus front face.

A gap part 10 of a roughly equal width throughout the whole in the circumferential direction of the hole 8 is set between the inner peripheral margin 8a of the hole 8 of the casing 3 on the front side of the apparatus and the peripheral wall 6b of the cover member 6. Accordingly, in the circuit board 4, the gap part between the inner peripheral margin 8a of the hole 8 made on the casing 3 on the apparatus front face and the peripheral wall 6b of the cover member 6 reaches the circuit board 4 side along the peripheral wall 6b of the cover member 6 and the side face 5a of the pointing device 5.

A conductor 11 piercing the circuit board 4 in the thickness direction from the upper face 4a of the circuit board 4 is provided. The conductor 11 is made up of a ground member 11a formed on the upper face 4a of the circuit board 4, a ground member 11b formed on a lower face 4b of the circuit board 4, and a through hole 11c piercing the circuit board 4 and connecting both the ground members 11a and 11b.

Further, a gasket 11d provided between the casing 2 on the apparatus base side and the circuit board 4 is connected to the ground member 11b formed on the lower face 4b of the circuit board 4. A gasket provided by wrapping a conductive cloth around the surrounding of urethane, for example, is adopted as the gasket 11d. The casing 2 on the apparatus base side where the gasket 11d is placed is made of metal or at least a part of the casing 2 is provided with metal, whereby the casing 2 has a metal part for conducting with the gasket 11d. A conductive member for electrically connecting the metal part of the casing 2 and the ground member 11b provided on the lower face 4b of the circuit board 4 may be provided in place of the gasket 11d.

To allow static electricity entering through the gap part 10 to easily arrive, it is desirable that at least a part of the ground member 11a should be provided at a position opposed to the gap part 10 in the upper face 4a of the circuit board 4.

Accordingly, static electricity entering the apparatus inside through the gap part 10 (arrow E) can be discharged into the casing 2 on the apparatus base side. That is, the static electricity entering the apparatus inside through the gap part 10 (arrow E) is discharged into the casing 2 on the apparatus base side through the ground member 11a formed on the upper face 4a of the circuit board 4, the ground member 11b formed on the lower face 4b of the circuit board 4, the through hole 11c piercing the circuit board 4 and connecting both the ground members 11a and 11b, and the metal gasket 11d.

The ground member 11a is formed at a position out of the cover member 6 on the upper face 4a of the circuit board 4. The cover member 6 isolates the ground member 11a and the pointing device 5, whereby static electricity can be made hard to arrive at the pointing device 5. Although it is desirable that the ground member 11a should be provided at a position out of the cover member 6 as shown in FIG. 2, if an allowable level in resistance to static electricity is satisfied, a part of the ground member 11a may enter a position surrounded by the cover member 6.

Thus, in the embodiment, the conductor 11 includes the through hole 11c and the through hole 11c is connected to the metal part of the casing 2 on the apparatus base side. The surrounding of the pointing device 5 is covered with the cylindrical cover member 6 and the cover member 6 isolates the pointing device 5 through the gap part 10 between the inner peripheral margin 8a of the hole 8 made on the casing 3 on the apparatus front face and the peripheral wall 6b of the cover member 6.

The surrounding of the pointing device 5 is covered with the cylindrical cover member 6, the ground members 11a and 11b are formed in the surrounding of the pointing device 5 in the circuit board 4, and a path where static electricity E propagating on the outer peripheral surface of the cover member 6 is applied to the circuit board 4 is formed. This path is connected to the casing 2 on the apparatus base side in close vicinity to the ground members 11a and 11b in the surrounding of the pointing device 5, thereby forming an electrostatic path for discharging the static electricity entering the inside of the circuit board 4 into the casing 2 on the apparatus base side.

In the embodiment, the gap part 10 communicating with the hole 8 on the casing 3 on the apparatus front face reaches directly the circuit board 4 along the side face 5a of the pointing device 5. The conductor 11 piercing the circuit board 4 along the board thickness direction is provided from the upper face 4a of the circuit board 4 opposed to the gap part 10 to the lower face 4b opposed to the casing 2 on the apparatus base side.

The conductor 11 is configured with the ground member 11a formed on the upper face 4a of the circuit board 4 and separated from the circuit pattern, the through hole 11c piercing the circuit board 4, and the ground member 11b connected to the through hole 11c. The ground members 11a and 11b are connected to the metal part provided in at least a part of the casing 2 on the apparatus base side, thereby forming an electrostatic path for discharging the static electricity entering the inside of the apparatus through the gap part between the hole 8 and the cover member 6 into the casing 2 on the apparatus base side.

In the embodiment described above, the surrounding of the pointing device 5 is covered with the cover member 6 with no space, whereby static electricity is not directly applied to the pointing device 5.

To prevent static electricity from being applied to the pointing device 5 through the gap between the cover member 6 and the circuit board 4, the circuit board 4 is formed with the ground members 11a and 11b to provide a function of a lightning rod. Static electricity is introduced into the ground members 11a and 11b, whereby static electricity can be prevented from being applied to the pointing device 5.

Further, the ground members 11a and 11b and the casing 2 on the apparatus base side are connected, thereby discharging static electricity into the casing 2 on the apparatus base side which becomes large GND. Accordingly, static electricity applied to the circuit board 4 can be prevented from flowing into the pointing device 5 through the gasket 11d.

According to the configuration described above, the electrostatic path is created, whereby the resistance on static electricity of the apparatus can be enhanced. That is, in the configuration in the related art, the distance between the pointing device 5 and the circuit board 4 is very short and in a resin casing with no conductive coating on the casing core face, static electricity applied to the surrounding of the pointing device 5 is applied directly to the circuit board 4 and the static electricity is applied to the pointing device 5, whereby the pointing device 5 is destroyed or malfunctions. In contrast, in the configuration of the embodiment, the surrounding of the pointing device 5 is covered with the cylindrical cover member 6, the ground members 11a and 11b are formed in the surrounding of the pointing device 5 in the circuit board 4, and the path where the static electricity E propagating on the outer peripheral surface of the cover member 6 is applied to the circuit board 4 is formed. This path is connected to the casing 2 on the apparatus base side in close vicinity to the ground members 11a and 11b in the surrounding of the pointing device 5, thereby forming the electrostatic path for discharging the static electricity entering the inside of the circuit board 4 into the casing 2 on the apparatus base side.

The configuration is adopted, whereby the pointing device 5 having low resistance on static electricity can be protected and the resistance on static electricity as the apparatus can be enhanced.

Further, the casing 3 on the apparatus surface side can be formed mainly of a resin to provide a simple configuration and metal need not be placed on the apparatus surface, so that there is no fear of impairing the communication function, the configuration can be simplified, the number of the components can be decreased, the manufacturing of the apparatus can be facilitated, etc.

As described above, according to the embodiment of the invention, there can be provided an electronic apparatus capable of preventing static electricity from being applied directly to a pointing device and protecting the pointing device.

It is to be understood that the present invention is not limited to the specific embodiment described above and that the present invention can be embodied with the components modified without departing from the spirit and scope of the present invention. The present invention can be embodied in various forms according to appropriate combinations of the components disclosed in the embodiment described above. For example, some components may be deleted from the configurations as described as the embodiment.

What is claimed is:

1. An electronic apparatus comprising:
a circuit board;
a pointing device mounted on the circuit board;
a cover member for covering the pointing device;
a first casing provided with a metal part, in which the circuit board is disposed;
a second casing joined to the first casing and having a hole that allows a part of the cover member to be exposed outside;
a conductor provided in the circuit board at a position opposed to a gap between the cover member and the second casing; and
a conductive member for electrically connecting the conductor and the metal part.

2. The apparatus according to claim 1, wherein the conductor includes a piercing member piercing the circuit board in a thickness direction thereof.

3. The apparatus according to claim 2, wherein:
the ground member includes a first ground member provided on an upper face of the circuit board and a second ground member provided on an lower face of the circuit board; and
the second ground member and the conductive member are electrically connected.

4. The apparatus according to claim 2, wherein the cover member is mounted on the circuit board and the conductor is provided at a position out of the cover member on the circuit board.

5. The apparatus according to claim 3, wherein an entire of the second casing or at least a portion around the hole of the second casing is formed of a resin.
